(19) United States
(12) Patent Application Publication
(10) Pub. No.: US 2026/0359888 A1
(43) Pub. Date: Nov. 12, 2026

(54) SYSTEMS AND METHODS FOR REMOTE PERSONAL DATA RETRIEVAL FOR OFFERING CREDIT OVER A WIDE AREA NETWORK

(71) Applicant: Pre-Fi LLC, Las Vegas, NV (US)

(72) Inventors: Lee RAMSEY, San Diego, CA (US); Erik GANTZ, Las Vegas, NV (US)

(73) Assignee: Pre-Fi LLC, Las Vegas, NV (US)

(21) Appl. No.: 19/671,379

(22) Filed: May 8, 2026

Related U.S. Application Data
(60) Provisional application No. 63/801,891, filed on May 8, 2025.

(51) Int. Cl. G06Q 40/03

(52) U.S. Cl. CPC G06Q 40/03

(57) ABSTRACT

Remote personal data retrieval (RPDR) methods and systems for offering credit over a wide area network are disclosed. An RPDR server receives from a client portal pre-qualification information consisting of at least two of: a user's name, a telephone number of the user and an email address of the user. A search and validation process obtains, over the network, identification information including a birth date of the user, at least one physical address of the user and/or a legal name of the user. The RPDR server obtains a credit report by transmitting a search request including at least a portion of the pre-qualification information and at least a portion of the identification information, and receiving the credit report from a reporting vendor server to generate and provide a credit offer. All information obtained from the user that is employed to obtain the credit report is at most the pre-qualification information.

### CROSS REFERENCE TO THE RELATED APPLICATIONS

This application is based upon and claims priority to U.S. Provisional Application No. 63/801,891, filed on May 8, 2025, the entire contents of which are incorporated herein by reference.

### TECHNICAL FIELD

The present disclosure relates to computer networks and, more particularly, to remote personal data retrieval for offering credit over a wide area network.

### BACKGROUND

An important concern with employing computer networks and the internet in particular is security of personal information input and transmitted on the networks. For example, with respect to obtaining offers for credit over a computer network, users can be reluctant to input sensitive private information, such as a home address or social security number, thereby forgoing or delaying submitting an application for credit, despite the relative security of transmitting such personal information using protocols such as hypertext transfer protocol secure, among others. Thus, there is a need for a technical means for overcoming this problem and enabling users to submit applications for credit by providing simple, basic personal information that would not be considered private and provides minimal risk of security breaches or fraud.

### SUMMARY

The present application provides a technical means for utilizing an alternate data routing path on computer networks for sensitive personal information that obviates the need for a user to enter it when, for example, applying for credit. In particular, embodiments of the present application enable the user to enter, through a client portal, at most a user's name, a telephone number of the user and/or an email address of the user. Here, in accordance with one exemplary aspect, the data retrieval system transmits search requests over a wide area network to various vendor servers to receive remaining personal private information used to obtain a credit report of the user. Thus, in this way, for example, the system establishes and leverages secure alternate data routing paths on the network to obtain the personal information, thereby enabling the user to provide only basic personal information with minimal risk of security breaches.

The present disclosure is directed to technical improvements in remote personal data retrieval and network-based credit-offer generation systems. In particular, disclosed embodiments provide a remote personal data retrieval architecture that reduces the amount of sensitive information entered by a user through a client portal and instead obtains and validates identity information through controlled, server-mediated communications with distributed vendor servers over a wide area network. The disclosed systems and methods implement cascading multi-vendor search and validation, confidence-threshold-based identity verification, clearing of personally identifiable information from failed validation attempts, and pre-full-pull bureau precheck processing that can terminate a credit-pull pipeline before execution of a full credit pull when stop-processing conditions are detected. By structuring the network workflow in this manner, the disclosed technology improves the operation of computer-implemented personal data retrieval systems by minimizing user-provided sensitive data, reducing unnecessary transmission and retention of personally identifiable information, and controlling when downstream reporting-vendor requests are permitted to proceed.

One exemplary embodiment is directed to a remote personal data retrieval method for offering credit over a wide area network. In accordance with the method, a remote personal data retrieval (RPDR) server receives from a client portal over the wide area network pre-qualification information, where the prequalification information consists of at least two of: a user's name, a telephone number of the user and an email address of the user. In addition, the RPDR server performs cascading multi-vendor search and validation process that establishes a verified consumer identity from the pre-qualification information without requiring a Social Security Number. The search and validation process includes generating a first search request including at least a portion of the pre-qualification information, transmitting the first search request to at least one identification (ID) vendor server over the wide area network, and receiving identification information from the ID vendor server over the wide area network. Here, the identification information comprises at least one of: a birth date of the user, at least one physical address of the user or a legal name of the user. The search and validation process further includes applying a confidence scoring threshold to the identification information, and, when the confidence scoring threshold is not satisfied, clearing personally identifiable information (PII) data captured from a failed attempt and initiating a new search cycle through another ID vendor server. Further, the RPDR server obtains at least one credit report of the user by performing, before executing a full credit pull, a lightweight credit bureau precheck address cascade that validates the verified consumer identity against credit bureau records by sequentially attempting a primary address, a first historical address when the precheck fails with the primary address, and second historical address when the precheck fails with the first historical address, terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy; generating a second search request including at least a portion of the pre-qualification information and at least a portion of the identification information; transmitting the second search request to at least one reporting vendor server over the wide area network; receiving the credit report(s) from the reporting vendor server in response to the second search request, where all information obtained from the user that is employed to obtain the credit report is at most the pre-qualification information; computing a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null; and when multiple credit bureau reports are available, calculating independent score values for respective credit bureaus and selecting a score having a value less than remaining independent score values as the qualifying score of the use. In addition, the RPDR server provides a credit offer to the user by generating the credit offer based on the credit report and on the qualifying score, and transmits the credit offer to the client portal over the wide area network.

In accordance with one exemplary aspect, the vendor server comprises a first ID vendor server that provides the identification information to the RPDR server. Here, the search and validation process performed by the RPDR server includes generating a third search request comprising the telephone number of the user to determine whether the telephone number of the user is valid, transmitting the third search request to a second ID vendor server over the wide area network and receiving, from the second ID vendor and over the wide area network, an indication of whether the telephone number of the user is valid.

In accordance with one exemplary version of the embodiment, the generating the first search request and the transmitting the first search request is performed on condition that the indication indicates that the telephone number of the user is valid.

According to an additional aspect, the portion of the prequalification information is the user's name, the indication comprises a locale associated with the telephone number and the second search request includes the locale. Here, the locale can be, for example, at least one of a city associated with the telephone number or a state associated with the telephone number.

In accordance with one exemplary aspect, the computing the qualifying score includes applying the first formula by scaling internal points by a geographic state-tier weight, multiplying the scaled internal points by the six-tier revolving paydown multiplier, and adding a base offset of the second threshold.

In a further exemplary aspect, the six-tier revolving paydown multiplier adjusts scoring sensitivity based on revolving credit utilization percentage such that the six-tier revolving paydown multiplier decreases as the revolving credit utilization percentage increases.

According to another exemplary aspect, the non-linear power-function fallback formula is applied to prevent score collapse for a consumer having multiple negative credit factors.

Additionally, in accordance with another exemplary aspect, the user's name includes a first name and a last name, and the portion of the prequalification information includes the first name and the telephone number. Here, the search and validation process comprises generating a third search request including the last name and the telephone number, transmitting the third search request to the ID vendor server over the wide area network, and receiving second identification information from the vendor server over the wide area network in response to the third search request.

Further, according to another exemplary aspect, the search and validation process includes generating a fourth search request including the e-mail address and the telephone number, transmitting the fourth search request to the ID vendor server over the wide area network, receiving third identification information from the ID vendor server over the wide area network in response to the third search request, comparing the first, second and third identification information to determine whether the third identification information matches any of the first or the second identification information, and determining that a match between the third identification information and the first or the second identification information corresponds to the user. Here, the portion of the identification information in the second search request includes at least a portion of the identification information of the match.

Another exemplary embodiment is directed to a non-transitory computer readable storage medium comprising program code, where the program code is configured to cause at least one processor to perform the method when the processor executes the program code.

An alternative exemplary embodiment is directed to a system for remote personal data retrieval for offering credit over a wide area network including a search and validation (SV) module, an underwriting (UW) module and an offer generator module. Here, each of the modules are implemented by at least one hardware processor. The processor, in implementing the SV module, is configured to receive, from a client portal over the wide area network, pre-qualification information, where the prequalification information consists of at least two of: a user's name, a telephone number of the user and an email address of the user. In addition, the processor, in implementing the SV module, is further configured to perform cascading multi-vendor search and validation process that establishes a verified consumer identity from the pre-qualification information without requiring a Social Security Number by generating a first search request including at least a portion of the prequalification information, transmitting the first search request to at least one ID vendor server over the wide area network, receiving identification information from the ID vendor server over the wide area network, where the identification information comprises at least one of a birth date of the user, at least one physical address of the user or a legal name of the user, applying a confidence scoring threshold to the identification information, and, when the confidence scoring threshold is not satisfied, clearing PII data captured from a failed attempt and initiating a new search cycle through another ID vendor server. Further, the processor, in implementing the UW module, is configured to obtain at least one credit report of the user by performing, before executing a full credit pull, a lightweight credit bureau precheck address cascade that validates the verified consumer identity against credit bureau records by sequentially attempting a primary address, a first historical address when the precheck fails with the primary address, and a second historical address when the precheck fails with the first historical address; terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy; generating a second search request including at least a portion of the pre-qualification information and at least a portion of the identification information, transmitting the second search request to at least one reporting vendor server over the wide area network, and receiving the credit report(s) from the reporting vendor server in response to the second search request, where all information obtained from the user that is employed to obtain the credit report is at most the pre-qualification information; computing a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null; and when multiple credit bureau reports are available, calculating independent score values for respective credit bureaus and selecting a score having a value less than remaining independent score values as the qualifying score of the user. Moreover, the processor, in implementing the offer generator module, is configured to provide a credit offer to the user by generating the credit offer based on the credit report and on the qualifying score, and transmitting the credit offer to the client portal over the wide area network.

Another exemplary embodiment is directed to a system for remote personal data retrieval for offering credit over a wide area network including an RPDR server implemented by at least one processor, a client portal, at least one ID vendor server and at least one reporting vendor server. The client portal configured to transmit, over the wide area network, pre-qualification information, where the prequalification information consists of at least two of: a user's name, a telephone number of the user and an email address of the user. In addition, the processor, in implementing the RPDR server, is configured to perform cascading multi-vendor search and validation process that establishes a verified consumer identity from the pre-qualification information without requiring a Social Security Number by generating a first search request including at least a portion of the pre-qualification information, transmitting the first search request to the ID vendor server over the wide area network, receiving identification information from the at ID vendor server over the wide area network, where the identification information comprises at least one of a birth date of the user, at least one physical address of the user or a legal name of the user, applying a confidence scoring threshold to the identification information, and, when the confidence scoring threshold is not satisfied, clearing personally identifiable information (PII) data captured from a failed attempt and initiating a new search cycle through another ID vendor server. Further, the processor, in implementing the RPDR server, is configured to obtain at least one credit report of the user by performing, before executing a full credit pull, a lightweight credit bureau precheck address cascade that validates the verified consumer identity against credit bureau records by sequentially attempting a primary address, a first historical address when the precheck fails with the primary address, and a second historical address when the precheck fails with the first historical address; terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy; generating a second search request including at least a portion of the pre-qualification information and at least a portion of the identification information, transmitting the second search request to at least one reporting vendor server over the wide area network, and receiving the credit report(s) from the reporting vendor server in response to the second search request, where all information obtained from the user that is employed to obtain the credit report is at most the pre-qualification information; computing a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null; and when multiple credit bureau reports are available, calculating independent score values for respective credit bureaus and selecting a score having a value less than remaining independent score values as the qualifying score of the user. The processor, in implementing the RPDR server, is configured to provide a credit offer to the user by generating the credit offer based on the credit report and on the qualifying score, and transmitting the credit offer to the client portal over the wide area network.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a high-level block diagram of a remote personal data retrieval and credit offering system in accordance with an exemplary embodiment; and

FIG. 2 is a high-level flow diagram of remote personal data retrieval method for offering credit over a wide area network in accordance with an exemplary embodiment.

### DETAILED DESCRIPTION

The technical solutions of the present disclosure will be clearly and completely described below with reference to the drawings wherein like reference numerals are used to refer to like elements throughout. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

Embodiments of the present application are directed to a computer-implemented platform for automated consumer pre-qualification in the lending industry. Through a novel cascading identity resolution algorithm, credit scoring formulas, and a dynamic offer generation engine, the platform can pre-qualify consumers for financial products using only minimal personally identifiable information (name, phone number, and email address)—without requiring a Social Security Number. The system operates as a multi-tenant Software as a Service (SaaS) platform, where lending partners configure their own underwriting criteria, credit models, and offer templates through a rules engine that uses parametric equation evaluation, eliminating the need for code deployment when business rules change.

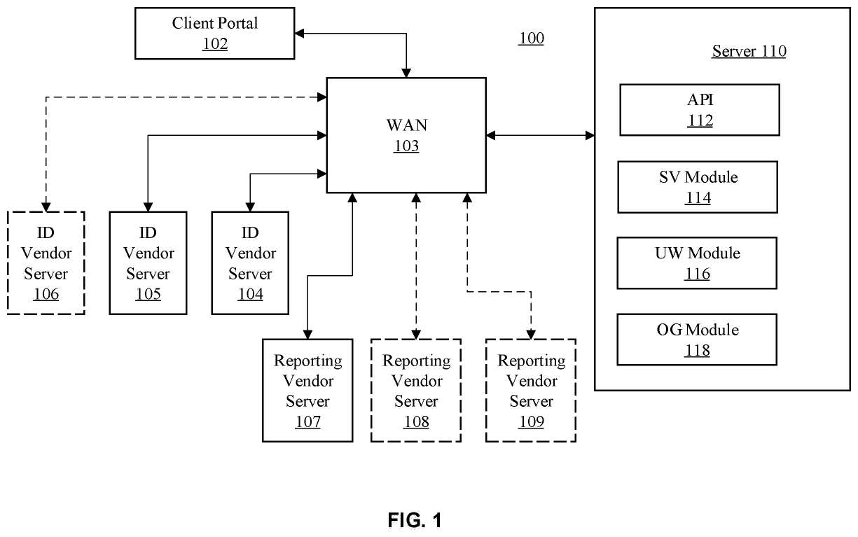

With reference now to FIG. 1, a remote personal data retrieval and credit offering system 100 in accordance with an exemplary embodiment is illustratively depicted. The system 100 includes a client portal 102, a wide area network 103, an identification (ID) vendor server 104, an ID vendor server 105, a reporting vendor server 107 and a remote personal data retrieval and credit offering server 110. The system 100 can optionally include an additional ID vendor server 106 and additional reporting vendor servers 107 and 108. It should be understood that additional ID vendor servers and reporting vendor servers can be included in the system 100 and employed by the server 110. The client portal 102 can be implemented as a personal computer or a mobile terminal, such as a smartphone or tablet, for example. In addition, the wide area network 103 is preferably the internet, but could be implemented as any type of wide area network. Further, each of the vendor servers 104-109 can be implemented with respective computer systems, including local computers and corresponding hardware processors and networks and/or cloud computing systems. In addition, the server 110 includes an application program interface (API) 112, a search and validation (SV) module 114 an underwriting (UW) module 116 and an offer generator (OG) module 118. The server 110, the application program interface 112, the SV module 114, the UW module 116 and the offer generator module 118 can be implemented by a computer system, including one or more processors that employ Random Access Memory (RAM) and/or Read Only Memory (ROM), and/or can include storage devices, such as, for example, solid-state drives (SSDs), on which computer program instructions can be stored and implemented by the processor(s) to perform the methods disclosed herein. In particular, a computer processor can implement each of the server 110, the application program interface 112, the SV module 114, the UW module 116 and the offer generator module 118, where the processor is configured to perform the steps of methods described herein in implementing the constituent elements of the server 110. The server 110 can also be implemented with and/or employ cloud computing as well.

The server 101 architecture, in a preferred embodiment, executes on a cloud computing platform using managed compute instances running PHP 8.2 on a 64-bit Linux operating system. Two distinct deployment environments are maintained: a production environment and a test/staging environment. The application server instances are provisioned with load balancing and auto-scaling capabilities, enabling horizontal scaling in response to variable API request volumes. Moreover, with regard to the data storage layer in a preferred embodiment, persistent data is stored in a relational database comprising approximately 55 entity tables managed through an object-relational mapping (ORM) framework. The database schema stores customer records, partner configurations, credit model definitions (including factors, tiers, groups, and results), credit report data, generated offers, and comprehensive API audit logs. Binary assets including images and documents are stored in cloud-based object storage, providing durable and scalable file persistence. With respect to the network architecture, in a preferred embodiment, the server 101 communicates with multiple external vendor APIs over HTTPS-encrypted connections through the network 103, including one or more credit bureaus (e.g., Experian, Equifax, TransUnion), identity data providers, address validation services, email verification services, phone validation services, property valuation services, and payment processing services. Each vendor integration is implemented as a dedicated service class with standardized request/response normalization, error handling, and audit logging. In a preferred embodiment, the application is built on a hypertext preprocessor (PHP) web application framework with dependency injection, annotation-based routing, and a service container architecture. Frontend assets are compiled through a module bundler, supporting both the embedded widget interface and the administrative dashboard.

In accordance with an exemplary embodiment, the API module 112 is a multi-tenant orchestration pipeline. In one embodiment, the API module 112 serves as the central orchestration layer that receives pre-qualification requests and coordinates the execution of all downstream modules in a defined sequence. The system exposes two primary API interfaces. The first API interface is a Widget API, which is a prequalification (PQ) API. The Widget API receives pre-qualification requests from embedded JavaScript widgets deployed on partner websites. Upon receiving a request at the /api/pq/pq endpoint, the system performs the following orchestrated sequence:
Partner Validation: The system validates the requesting partner via a unique widget code (pqId), verifies the partner's account status is active, and confirms sufficient transaction capacity remains on the partner's billing plan.
IP Geolocation Fraud Check: The consumer's internet protocol (IP) address is validated against an IP geolocation service to confirm the request originates from a permitted jurisdiction (United States). Requests from non-US IP addresses are rejected with specific status codes (150-151).
Duplicate Detection: If the partner has enabled duplicate checking, the system queries for existing customers matching the submitted email, phone, name, and IP address combination to prevent redundant credit inquiries.
Email Verification: The submitted email address is validated through an email verification service to confirm deliverability. Statuses of ‘valid,’ ‘catchall,’ and ‘unknown’ pass; ‘invalid’ emails are rejected.
Phone Verification with Voice over Internet Protocol (VoIP) Detection: The phone number is validated through a phone validation service, which returns a PhoneTypeCode. Code 3 (VoIP) triggers rejection based on partner configuration, as VoIP numbers are associated with higher fraud risk. The carrier name, geographic location, and country code are also captured.
Age Validation: The system verifies the consumer is at least 21 years of age before proceeding.
SV Module 114 Execution: The cascading identity resolution algorithm is invoked. Details of the cascading identity resolution algorithm are provided below.
Credit Pull with Progressive Retry: Credit reports are ordered from one or more bureaus using personally identifiable information (PII) enriched by the SV Module 114, with automatic retry using alternative PII combinations on failure, detailed further herein below.
Credit Model Processing: The retrieved credit report is evaluated against the partner's configured credit models, detailed further herein below.
Offer Generation: Qualifying results trigger dynamic assembly of pre-qualified loan offers, detailed further herein below.

The second primary API is a Partner REST API (V1/V2 API) in a preferred embodiment. The Partner REST API provides programmatic access for partners to submit pre-qualification requests and retrieve results. This interface adds an additional security and rate-limiting layer including Bearer Token Authentication, Per-Partner Rate Limiting, PII Protection in Audit Logs, Comprehensive Audit Trail. With respect to Bearer Token Authentication, each request must include a valid 32-character access token in the Authorization header, linked to a specific partner account. With regard to Per-Partner Rate Limiting, the API 112 tracks request volume per partner per minute, enforcing a configurable rate limit (default: 20 requests/minute in accordance with a preferred embodiment). Excess requests receive HTTP 429 responses. With respect to the PII Protection in Audit Logs, all request/response payloads are logged with sensitive fields (SSN, DOB) automatically masked before persistence. For the Comprehensive Audit Trail, every API interaction is recorded in a DataPartnerLog entity capturing the provider, API method, request/response bodies, HTTP headers, client IP, browser fingerprint, referrer, timestamps, response codes, and linked customer/entity references.

Concerning the multi-tenant partner configuration, each partner in the system maintains an independent configuration that controls every aspect of the pre-qualification pipeline. This includes: which credit report products (SKUs) to order (primary and secondary), which credit models to apply, which score types to use (Vantage 4, FICO 5, FICO 8, FICO 8 Auto, FICO 10T), whether to require email/phone verification, whether VOIP phones are permitted, duplicate checking behavior, data append options, custom branding (colors, disclaimers, button text, FCRA compliance language), advertising pixel configurations, billing parameters, and rate limits. This configuration-driven architecture enables each partner to operate with a completely independent underwriting strategy without requiring code modifications.

In accordance with one embodiment, the SV module 114 implements a cascading multi-vendor identity resolution algorithm. In one embodiment, the SV module 114 implements a novel cascading identity resolution algorithm that establishes a verified consumer identity from minimal input (first name, last name, phone number, and email address) without requiring a Social Security Number. This is achieved through a multi-vendor waterfall search strategy with confidence scoring, progressive search relaxation, and cross-vendor failover.

With respect to vendor selection logic, the SV module 114 in one embodiment selects the primary identity search vendor based on the partner's configuration. The default is a first identity data provider, with a second identity data provider as the fallback. However, if the partner's configuration requires property data, investable assets data, background records, or a secondary credit report, the system routes directly to the second identity data provider as primary, because it provides richer PII data sets required for these downstream operations.

Turning now to the first identity provider search path (primary vendor), when the first identity data provider is selected as the primary vendor, the system submits the consumer's phone number, first name, and last name to the provider's contact enrichment API endpoint. The response includes an identity confidence score (numeric). The system applies a threshold of identity score greater than or equal to 90 in one embodiment. If the threshold is met and a person object is returned, the search is deemed successful and the system assigns a PII Append Status of 10, indicating high-confidence identity resolution. The resolved PII (legal name, addresses, date of birth) is extracted and associated with the customer record for use in downstream credit pull operations.

With respect to the second identity provider search path (fallback/alternative primary), when the second identity data provider is selected (either as a fallback after the first provider's failure or as the primary vendor), the SV module 114 executes a series of progressively relaxed search permutations, each designed to maximize the probability of identity resolution while minimizing false positives:
Full Name+Phone Search (Status 10): The system submits first name, last name, and phone number. Nickname matching is enabled (nicknamesearch: true) to capture common name variations. Success requires at least one result record.
Last Name+Phone Search (Status 11): If the first search fails, the first name is dropped, searching only by last name and phone number. This captures cases where the consumer's first name differs from official records.
First Name+Phone Search (Status 12): If the second search fails, the last name is dropped, searching only by first name and phone number. This captures cases of name changes (e.g., marriage).
Email Reverse Lookup with Name Matching (Status 20): If all phone-based searches fail, the system performs a reverse email lookup and then validates the returned results by checking whether the consumer's submitted first name OR last name appears in the result set. This cross-referencing step prevents false identity matches from common email addresses.
Each search permutation requests a comprehensive data set from the second identity data provider including: name records, address history, email addresses, date of birth, phone numbers, death records, bankruptcy records, criminal records, liens, and judgments. The integration fields requested via the API ensure that downstream modules (credit pull, property assessment, background screening) have the maximum available PII to work with.

It should be noted that an important aspect of the SV module 114 is its cross-vendor failover capability. In one embodiment, if the first identity data provider fails to resolve the consumer's identity (identity score below threshold or no person object returned), the system does not simply report failure. Instead, it clears the PII data captured from the failed attempt and initiates a complete new search cycle through the second identity data provider, executing the four-permutation waterfall described above. This ensures maximum identity resolution coverage by leveraging complementary data sources across vendors, as each vendor may have coverage gaps for different consumer demographics

Upon successful identity resolution, the SV module 114 provides a PII enrichment output. In particular, the SV Module 114 produces an enriched consumer profile that includes: legal first and last name (which may differ from submitted names), up to three historical addresses with street, city, state, zip, and zip+4, date of birth, age, and the identity resolution confidence metadata (vendor ID, status code, identity score). Each enriched data point is tagged with its source (vendor ID) to maintain provenance throughout the pipeline. This enriched profile is the foundation for the progressive credit pull retry algorithm, an embodiment of which is described in more detail herein below.

In accordance with one embodiment, the UW module 116 can include a credit pull module that implements the progressive credit pull retry algorithm. Here, in one embodiment, the credit pull module implements a novel progressive retry algorithm that maximizes the probability of obtaining a credit report by systematically enriching the credit bureau request with additional PII obtained from the SV module 114. This addresses a fundamental challenge in the lending industry: credit bureaus frequently return ‘No Hit’ responses when the submitted consumer PII does not precisely match bureau records. For example, the credit pull module selects a credit report product (SKU). For example, the credit pull module first determines which credit report product (SKU) to order based on the partner's configuration. In one embodiment, the SKU selection logic considers: the partner's configured score type (Vantage 4, FICO 5, FICO 8, FICO 8 Auto, FICO 10T), whether the partner requires income verification, the consumer's age, and the PII append status from the SV module 114. For consumers with high-confidence identity resolution (status<20), in one embodiment, the credit pull module may order from a preferred credit bureau reseller at 96% probability or a secondary bureau endpoint at 4% probability, implementing A/B testing of credit report sources to optimize hit rates and costs.

Before executing a full credit pull, in one embodiment, the credit pull module performs a lightweight credit bureau precheck address cascade to validate the consumer's identity against the credit bureau's records. This precheck is itself a cascading algorithm that tries up to three addresses:
Primary Address: The first address from the SV module's identity resolution results is used. The precheck validates the consumer's identity and returns hit codes, age verification, and address discrepancy indicators.
Second Address: If the precheck fails with the primary address, the system loads the second historical address from the SV module results and retries the precheck.
Third Address: If the second address also fails, the system loads the third historical address and makes a final precheck attempt.

The precheck returns specific stop-processing signals for credit freezes (hit codes A, G), credit locks (hit codes L, M), age mismatches, and address discrepancies. These conditions cause immediate pipeline termination rather than wasted credit pull attempts, reducing both cost and unnecessary bureau inquiries.

For each credit report SKU, in one embodiment, the credit pull module executes a five-attempt credit pull retry waterfall. For example, the credit pull module can execute up to five credit pull attempts, each enriching the request with progressively different PII from the SV Module:
Attempt 1—Primary PII: Uses the consumer's submitted name and the primary address from identity resolution. If the bureau precheck passed, proceeds directly to the credit pull.
Attempt 2—Legal Name Enrichment: If Attempt 1 returns ‘NoHit,’ the credit pull module invokes the name append function to substitute the consumer's legal name (as found in identity search records) for the submitted name. This addresses cases where the consumer submitted a nickname, maiden name, or misspelled name.
Attempt 3—Date of Birth Enrichment: If Attempt 2 returns ‘NoHit,’ the credit pull module invokes the date of birth (DOB) append function. DOB is sourced hierarchically: first from a previously retrieved credit report (if available), then from the second identity data provider's search results, then from the first identity data provider's search results. Adding DOB to the request significantly improves bureau matching accuracy.
Attempt 4—Second Address Substitution: If Attempt 3 returns ‘NoHit,’ the system substitutes the second historical address from the identity search results. The consumer may have moved since their bureau file was last updated.
Attempt 5—Third Address Substitution: If Attempt 4 returns ‘NoHit,’ the system substitutes the third historical address, representing the consumer's oldest known address.

The retry waterfall terminates immediately on any non-NoHit error (e.g., credit freeze, system error, invalid SSN format). On success at any attempt, the credit report is captured and the pipeline proceeds to credit model processing. This progressive enrichment approach achieves significantly higher credit report retrieval rates compared to conventional single-attempt credit pull systems.

The UW module 116 can also implement a configurable credit scoring engine (Pref-fi Score). In one embodiment, the underwriting module implements a proprietary credit scoring algorithm (Pre-Fi Score) that evaluates consumer creditworthiness through a multi-factor, multi-bureau analysis with configurable partner rules, dynamic equation evaluation, and a novel dual-formula scoring system. While conventional credit scoring models such as Fair Isaac Corporation (FICO) offer industry-specific variants (e.g., FICO Auto, FICO Bankcard), these remain fixed methodologies that individual lenders cannot modify. The Pre-Fi Score takes a fundamentally different approach: it is fully customizable at the individual partner level, enabling each lender to define their own credit evaluation criteria for lead qualification tailored to their specific risk appetite, product types, and market segments.

A distinguishing feature of the Pre-Fi Score is its two-layer scoring architecture, implemented with a normalized internal scoring with conversion to standard ranges. In one embodiment, the UW module 116 first computes a normalized internal score on a 100-point scale by evaluating all active credit model factors against the consumer's credit report data. This 100-point internal score represents a granular, configurable assessment of creditworthiness that can be tuned independently for each partner and industry vertical. The internal score is then converted to a standard credit score range (300-850) using a conversion formula, enabling the Pre-Fi Score to be directly compared with and used alongside traditional FICO and Vantage scores in downstream lending decisions.

In one embodiment, the UW module 116 implements a pre-fi score dual-formula conversion algorithm. In particular, in one embodiment, the UW module 116 implements the conversion from the 100-point internal scale to the standard credit score range uses a two-stage approach:
Primary Formula: The internal points are scaled by a geographic state-tier weight (defaulting to 1.0 but configurable per state/region) and multiplied by a dynamic revolving paydown multiplier. The resulting value is added to a base offset of 600 to produce the converted credit score: Score=round(multiplier×points×stateTierWeight)+600. The revolving paydown multiplier is a six-tier graduated system that adjusts scoring sensitivity based on the consumer's revolving credit utilization percentage. At utilization of 40% or below, the default multiplier of 1.85 applies (maximum scoring benefit). As utilization increases, the multiplier decreases: 1.5 at 41-50%, 1.25 at 51-60%, 1.15 at 61-75%, 1.0 at 76-90%, 0.5 at 91-100%, and 0.33 above 100%. This graduated system ensures that consumers with high revolving debt receive proportionally lower scores, while rewarding consumers who maintain healthy utilization ratios.
Fallback Formula: When the primary formula produces a score below 600 or returns null (indicating severe credit issues), the system switches to a non-linear fallback formula: Score=round(945.72−137.03×|points|\hat{ }0.2). This power-function transformation prevents score collapse for consumers with multiple negative factors. The exponent of 0.2 ensures diminishing marginal impact of additional negative factors—the difference between 5 and 10 negative factors is much larger than the difference between 95 and 100 negative factors. The fallback score is bounded between 300 and 600.

To implement multi-bureau reconciliation, when multiple credit bureau reports are available, the UW module 116, in one embodiment, calculates independent Pre-Fi Score values for each bureau (Experian, Equifax, TransUnion) and selects the lowest score as the consumer's qualifying score. Bureau precedence for single-bureau calculations follows TransUnion (highest priority), then Equifax, then Experian. If a standard FICO or Vantage score is available from the bureau report, the system uses the lowest real estate score across all bureaus, falling back to Pre-Fi Score only when bureau-provided scores are unavailable

In addition, the UW module 116, in one embodiment, employs a factor and tier evaluation system. Herem credit model factors represent individual credit assessment criteria (e.g., payment history, credit utilization, account age, collections). Each factor is linked to a credit report variable that defines how to extract the relevant value from the credit report through a runtime-evaluable equation. The variable system supports multi-bureau reconciliation modes: single-bureau (use the specified bureau), lowest across all bureaus, highest across all bureaus, or sum of all bureau values. Further, each factor contains ordered tiers that define scoring thresholds. Tiers are evaluated in sequence until the first match is found. Four tier types are supported: Type 0 (default/fallback, matches when no other tier conditions are met), Type 1 (conditional, matches when the tier's equation evaluates to true), Type 2 (if-fixed only, applies exclusively when calculating improvement pathway scores), and Type 3 (penalty, subtracts points when the equation is true). Each tier maintains two point values: ‘as-is’ points (the consumer's current score contribution) and ‘if-fixed’ points (the score contribution if the consumer remediated the issue). This dual-point system enables the improvement pathway feature described below. Tier equations can reference both primary ($x) and secondary ($y) credit report variables, enabling complex multi-variable scoring conditions.

Moreover, the UW module 116, in one embodiment, employs dependent group aggregation. Here, factors can be organized into dependent groups that control how individual factor scores are aggregated. Each group defines separate rules for positive points (penalties) and negative points (bonuses): cumulative mode (sum all contributions), maximum mode (keep only the highest-impact contribution), or minimum mode (keep only the lowest-impact contribution). Groups also define maximum penalty caps and minimum bonus floors, preventing any single category from disproportionately affecting the total score. The final point aggregation starts from a base of 100 points and subtracts the group-adjusted penalty/bonus totals.

In accordance with one embodiment, an important technical feature of the UW module 116 is that the UW module 116 includes a dynamic equation evaluation engine. Factor tier conditions, credit report variable extraction formulas, and credit model result matching rules are all stored as text strings in the database and evaluated at runtime through a server-side expression evaluator. Variables available to these equations include: x (primary factor value), y (secondary factor value), CR (the complete credit report object), CU (the customer object), and CreditBureau (the current bureau being evaluated). This architecture enables partners to define arbitrarily complex underwriting rules—including multi-variable mathematical comparisons, logical combinations, and references to specific credit report attributes—without requiring application code changes or deployment cycles.

Further, the UW module 116, in one embodiment, generates personalized improvement pathways for consumers who do not immediately qualify. For each factor flagged as ‘fixable,’ the system evaluates both the ‘as-is’ and ‘if-fixed’ tier points and produces templated messages with variable substitution (e.g., ‘Pay down revolving balance to below $x %’). These messages are generated at both the partner level (detailed remediation instructions) and the consumer level (simplified, consumer-friendly guidance). The system also calculates time-delayed improvement pathways: factors with a ‘fixable wait’ period indicate improvements that will appear on the credit report after a specified number of days (30, 60, etc.), enabling ‘Wait 30’ and ‘Wait 60’ pre-qualification statuses.

In addition, in accordance with one embodiment, the UW module 116 implements per-partner and per-industry customization. A key advantage of the Pre-Fi Score in this particular embodiment over conventional scoring models is its full configurability at the partner and industry level. Each lending partner can maintain one or more credit models, each with its own set of factors, tiers, scoring weights, dependent groups, and result thresholds. This enables a mortgage lender to emphasize real estate payment history and debt-to-income ratios, while an unsecured business funding provider emphasizes revolving credit utilization and available credit. A single consumer's credit report may produce materially different Pre-Fi Scores when evaluated against different partner models, reflecting each partner's distinct risk tolerance and product requirements. New credit models can be created, cloned from existing models, and A/B tested across partner configurations without any code changes, providing a level of scoring agility unavailable with fixed-methodology scoring models, where individual lenders must accept predetermined scoring criteria regardless of their unique qualification needs.

In accordance with one exemplary embodiment, the UW module 116 employs a pre-qualification decision tree. Here, the pre-qualification status is determined through a hierarchical evaluation. For business funding (Type 0), the system calculates four score variants: As-Is (current credit profile), If-Fixed (after all fixable items remediated), Wait-30 (projected after 30 days), and Wait-60 (projected after 60 days). The consumer receives the highest applicable qualification status. Qualified leads are further tiered by loan amount: Tier 1 ($50,000+), Tier 2 ($30,000-$49,999), Tier 3 ($10,000-$29,999), or NQL (below $10,000). For mortgage products (Type 1), additional factors including property count, first-time homebuyer status, military association, combined DTI with co-borrowers, and underwriter review flags are incorporated into the decision.

In one embodiment, the UW module 116 includes a credit model result matching engine. For example, using the engine, the UW module 116, after scoring, the UW module 116 determines which configured results (and associated offers) the consumer qualifies for. The result matching engine supports two modes: equation-based matching, where a stored equation is evaluated with variables mapped from the pre-qualification output (amount, score, status, revolving credit, property count, first-time buyer flag, military flag, revolving balance), and range-based matching, where results are matched by status string and amount range (min/max). Multiple results can match simultaneously, enabling a consumer to qualify for multiple offer types from a single credit evaluation.

Turning now to the OG module 118, as indicated above the OG module 118 performs dynamic offer generation. In one embodiment, the offer generation module 118 dynamically assembles personalized loan offers based on the intersection of credit model results, partner-defined offer templates, and consumer-specific financial attributes. In one exemplary implementation, the OG module 118 employs offer template matching. Each partner configures offer templates that are associated with specific CreditModelResult outcomes. When a consumer's pre-qualification produces matching CreditModelResults, the OG module 118 identifies all offer templates linked to those results. An offer qualifies if any of its associated CreditModelResults matches the consumer's evaluation outcome. Previous offers for the consumer are archived (removed from the active set) before new offers are generated, ensuring the consumer always sees current, accurate offers.

Further, in one exemplary embodiment, the OG module 118 implements a mortgage offer assembly algorithm. Here, for mortgage products, the offer generation module 118. implements a sophisticated multi-factor calculation. The system retrieves the consumer's property data (estimated value, existing mortgage balance) and applies the partner's maximum LTV (Loan-to-Value) percentage to calculate the maximum loan amount. The offer amount is further constrained by the partner's maximum DTI (Debt-to-Income) ratio, which is calculated by dividing the consumer's total monthly payments (from the credit report) by their monthly income. Monthly payment calculations incorporate: principal and interest (using standard amortization formulas with support for both fixed-rate and ARM products), property taxes (sourced from regional estimates or property-specific data), homeowner's insurance (similarly sourced), PMI (Private Mortgage Insurance, applied on a tiered schedule based on credit score when LTV exceeds 80%, ranging from 0.46% to 1.5% of property value), and HOA fees where applicable. Regional estimates for property taxes and insurance rates are maintained in a CreditModelRegionEstimate table, enabling market-specific calculations.

Moreover, in one exemplary embodiment, the OG module 118 performs dynamic offer message rendering. Here, each generated offer includes a templated message rendered with consumer-specific and partner-specific variables. Supported template variables include: [Amount], [InterestRate], [MonthlyPayment], [MaxLTV], [MaxDTI], [Score], [Income], [DebtToIncome], [FirstName], [LastName], and [Code] (partner-specific promotional codes). The offer also includes contingency messages derived from the credit model's improvement pathway system, indicating what actions the consumer must take to finalize the offer.

Further, turning now to the reporting vendor servers 107-109, each of the reporting vendor servers 107-109 implement a normalized multi-provider abstraction layer in accordance with an exemplary embodiment. In this exemplary embodiment, the vendor server implements a normalized abstraction layer that provides a uniform interface to over at least ten external service providers. It should be understood that more or less than ten external service providers can be employed. Each vendor integration is implemented as a dedicated service class with standardized patterns:
Credential Management: Each vendor service class manages its own authentication (API keys, OAuth2 tokens, session-based authentication) independently.
Request Normalization: Consumer PII is mapped from the internal Customer entity format to each vendor's specific API schema.
Response Normalization: Vendor-specific response formats are parsed and normalized to a common internal data structure, enabling downstream modules to consume data from any vendor interchangeably.
Error Handling: Each vendor integration translates vendor-specific error codes to standardized internal error codes (e.g., ‘NoHit,’ ‘Freeze,’ ‘Lock’), enabling the retry waterfall logic to make consistent decisions regardless of which vendor is in use.
Audit Logging: Every vendor interaction is logged through the DataPartnerLog system with request/response bodies, timing data, and status codes, providing a complete audit trail for compliance and debugging.

The credit provider subsystem of each vendor server 107-109 uses a provider-based dispatching pattern where a CreditProviderManager delegates operations (subscribe, cancel, load, ping) to provider-specific implementation classes based on the configured CreditServiceProvider. This enables new credit bureau integrations to be added by implementing a standard interface without modifying the orchestration logic.

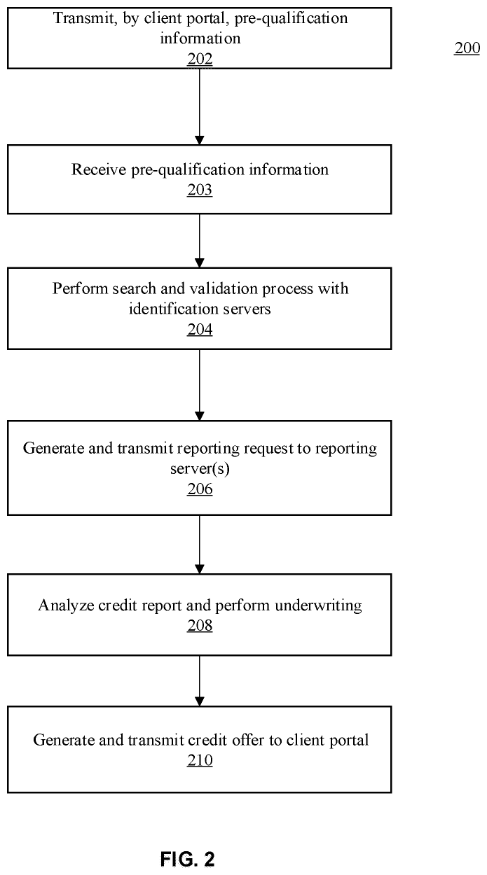

Referring now to FIG. 2, with continuing reference to FIG. 1, a remote personal data retrieval method 200 for offering credit over a wide area network is illustratively depicted. At step 202, the client portal 102 presents a credit pre-qualification form to a user. For example, the pre-qualification form can be presented in a user-interface of the client portal 102 in the form of a web page or an application page of an application downloaded and running on the client portal 102. Here, the web page can be transmitted from the server 110 to the client portal 102 through the wide area network 103. The pre-qualification form can prompt a user operating the client portal 102 to provide pre-qualification information, including the user's name, e-mail address and/or telephone number.

Continuing with step 202, the client portal 102 securely transmits the pre-qualification information in pre-qualification form completed by the user, i.e., the user's name, e-mail address and/or telephone number, to the application programming interface 112 of the server 110 over the wide area network 103. For example, Hypertext Transfer Protocol Secure can be employed to transmit the pre-qualification information to the server 110. In accordance with an exemplary aspect, the only personal information or pre-qualification information provided by the user is the user's name, the user's e-mail address and/or the user's telephone number.

At step 203, the SV module 114 receives the pre-qualification information from the client portal 102, and, at step 204, assesses the pre-qualification information and performs an identification search and validation process to verify the user's identification. For example, in accordance with one exemplary aspect, the SV module 114 generates and submits a search request including the user's telephone number to the ID vendor server 104 over the wide area network 103. Here, the ID vendor server 104 can be an Amazon Web Services (AWS) Pinpoint server that provides a response to the search request over the wide area network 103 that indicates whether the telephone number provided is valid. For example, the response to the search request can indicate the phone number type, e.g., mobile, landline or VoIP, the city or locality and country in which the phone number is based, and the service provider associated with the phone number.

Continuing with step 204, in response to receiving an indication from the ID vendor server 104 that the phone number of the search request is valid, the SV module 114 generates and submits a search request including at least one of the user's first name, last name and telephone number to the ID vendor server 105 over the wide area network 103. In response to the search request, the ID vendor server 105 can transmit over the wide area network 103 identification information of the user to the SV module 114. Here, the identification information can include at least one of a birth date of the user, a current home address of the user (hereinafter ‘first address’), a most recent home address of the user before the user was at the first address (hereinafter ‘second address’) and a most recent home address of the user before the user was at the second address (hereinafter ‘third address’) and/or a legal name of the user. For example, the ID vendor server 105 can be an Endato server, and the response to the search request provided by the ID vendor server 105 can include a percentage indicating the certainty that the identification information is accurate. In accordance with one exemplary implementation, the SV module 114 accepts the identification information as being accurate only if the percentage is equal to or greater than 95%. If so, the method can proceed to step 206. Optionally, the SV module 114 can conduct further processing before proceeding to step 206.

For example, continuing with step 204, the SV module 114 generates and submits a search request to an ID vendor server 106 over the wide area network 103, where the search request includes at least one of the user's first name, the user's last name, the user's telephone number, the user's email address and/or the user's location. Here, in accordance with one exemplary aspect, the ID vendor server 106 can be an Interactive Data (IDI) server. For example, the SV module 114 can include the user's first name, last name and telephone number in the search request. In response, the ID vendor server 106 can provide a response including identification information, which can include at least one of the birth date of the user, the first address of the user, the second address of the user, the third address of the user and/or the legal name of the user. If, for example, the ID vendor server 106 does not return a result based on the first name, last name and telephone number, then the SV module 114 can transmit three search requests to the vendor server 106 over the wide area network 106. For example, the first of the three search requests consists of the user's last name and telephone number; the second of the three search requests consists of the user's first name and telephone number; and the third of the three search requests consists of the user's e-mail address and telephone number. In response, the ID vendor server 106 transmits, over the wide area network 103, a first response to the first search request, a second response to the second search request, and a third response to the third search request. Each of the first, second and third responses can include results having one or more identifications of one or more people. Here, the SV module 114 cross-references and compares identifications in the first response and the third response to determine whether the email matches the first name, and cross-references and compares identifications in the second response and the third response to determine whether the email matches the last name. If an identification appears in the first response and the third response, where the email matches the first name, or in the second response and third response, where the email matches the last name, then the SV module 114 determines that the match corresponds to the user and determines that the identification information of the match is the user's identification information. For example, the SV module 114 determines that the identification information of the matched identification, where the identification information can include at least one of a birth date, a first address, a second address, a third address of the user and/or a legal name, belongs to the user.

Optionally, continuing with step 204, the SV module 114 can generate and submit a location-based search request to the ID vendor server 106 over the wide area network 103. For example, the location-based search request can be consist of the user's first name, the user's last name and the user's city or locale, where the user's city or locale can be obtained by the SV module 114 from the phone validation provided by the ID vendor server 104, as discussed above. Alternatively, the location-based search request can consist of the user's first name, the user's last name and the user's state, where the user's state can be obtained by the SV module 114 from the phone validation provided by the ID vendor server 104, as discussed above. In response to the location-based search request, the ID vendor server 106 can provide a response including identification information, which can include at least one of the birth date of the user, the first address of the user, the second address of the user, the third address of the user and/or the legal name of the user, as discussed above, to the SV module 114 over the wide area network 103. Here, the SV module 114 can determine that the identification information in the response to the location-based search request is the user's identification information on condition that the identification information is the only result provided in the response to the location-based search request. In accordance with one exemplary aspect, the generation and submission of the location-based search request can be performed by the SV module 114 on condition that the generation and submission of the first, second and third search requests employed to implement e-mail matching does not return any result or does not return a single result for the identification information. In accordance with another exemplary aspect, the generation and submission of the location-based search request can be performed by the SV module 114 prior to or in lieu of the generation and submission of the first, second and third search requests employed to implement e-mail matching.

At step 206, the UW module 116 generates at least one reporting request and transmits the reporting request to a reporting vendor server 107 over the wide area network 103. Optionally, a respective reporting request can be transmitted to optional reporting vendor server 108 and/or optional reporting vendor server 109. For example, the reporting vendor servers can be operated by various credit bureaus. For example, the reporting vendor server 107 can be an Equifax sever, the reporting vendor server 108 a TransUnion server and the reporting vendor server 109 can be an Experian server. Here, the reporting request(s) can include at least a portion of the identification information determined to belong to the user at step 204, as discussed above. For example, information of the user provided in a given reporting request can consist of: A) the user's first name, last name or legal name; and the first address; B) the user's first name, last name or legal name; and the birth date; C) the user's first name, last name or legal name; and the second address; or D) the user's first name, last name or legal name; and the third address. In response to the respective reporting request, the reporting vendor server 107 can transmit a first credit report for the user over the wide area network 103 to the server 110. Alternatively or additionally, in response to the respective reporting request, the reporting vendor server 108 and/or reporting vendor server 109 can transmit a second credit report for the user and/or a third credit report for the user, respectively, to the server 110 over the wide area network 103. In each of these cases, all information obtained from the user that is employed to obtain the credit report(s) is at most the pre-qualification information, which consists of at least one of the user's name, the telephone number of the user and the email address of the user.

At step 208, the UW module 116 of the server 110 receives and analyzes the credit report(s) transmitted by the ID vendor server 104, 105 and/or 106 in response to the reporting request(s) and performs an underwriting process. Here, the UW module 116 is an automated system that applies customizable criteria tailored to a credit provider's requirements. In one embodiment, the underwriting process involves an automated analysis of consumer credit reports to assess loan eligibility and assign pre-qualification status. The system retrieves credit data from one or more major credit bureaus (e.g., Experian, Equifax, TransUnion) and parses key attributes such as credit score, debt-to-income ratio, credit utilization, payment history, and public records. Credit provider partners are provided with a configurable rules engine or interface that allows them to define custom underwriting criteria—such as minimum credit score thresholds, maximum delinquency counts, or specific tradeline requirements. These criteria are applied to the incoming credit data to generate a real-time decision indicating whether the consumer pre-qualifies for a given loan product. The underwriting module ensures dynamic partner control over eligibility logic and supports consistent, automated credit evaluation.

At step 210, the offer generator module 118 generates at least one credit offer and transmits the credit offer through the API 112 to the client portal 102 over the wide area network. For example, the credit offer can be provided in the user-interface of the client portal 102 in the form of a web page or an application page of the application downloaded and running on the client portal 102. In one embodiment, once the user has been determined to meet the underwriting criteria by the UW module 116, loan offers are dynamically generated by the offer generator module 118 based on both credit provider partner-defined parameters and consumer-specific credit attributes. The offer generator module 118 may reference a partner's product catalog, which defines available loan terms such as amount ranges, interest rates, repayment periods, and promotional conditions. These parameters are matched against the consumer's qualified credit tier, income band, and other eligibility factors to determine suitable offer combinations. The offer generation logic applied by the offer generator module 118 may incorporate pricing models, risk-based rate adjustments, and decision trees or scoring algorithms to customize terms in real time. Generated offers are assembled into structured data payloads (e.g., JavaScript Objection Notation (JSON) objects), which can be displayed to the user through a digital interface through the client portal 102 or transmitted to credit provider partner systems via the API 112. This process ensures that users/consumers are only presented with pre-qualified, actionable loan offers tailored to their financial profile and partner-specific requirements.

Embodiments of the present application include several technical improvements. For example, exemplary embodiments implement cascading multi-vendor identity resolution without requiring an SSN. Here, a waterfall algorithm that resolves consumer identity using only name, phone, and email through progressively relaxed search permutations across multiple data providers, with confidence scoring thresholds and cross-vendor failover. This enables soft-pull pre-qualification without Social Security Numbers, a significant privacy and fraud-reduction advancement.

Another technical improvement is constituted by progressive PII enrichment credit pull retry according to exemplary embodiment. For example, in one exemplary implementation. A multi-attempt (e.g., five-attempt) retry algorithm that systematically enriches credit bureau requests with legal name, date of birth, and alternative addresses obtained from identity resolution, addressing the credit bureau ‘No Hit’ problem and achieving higher retrieval rates than single-attempt systems.

In addition, exemplary embodiments employ a normalized two-layer credit scoring with Per-Partner Customization: A proprietary scoring algorithm that first computes a normalized 100-point internal score using configurable factors and tiers that can be customized per partner and per industry, then converts to standard credit score ranges (300-850) using a dual-formula system with a six-tier dynamic revolving paydown multiplier and a non-linear power-function fallback that prevents score collapse. While FICO offers industry-specific model variants, these remain fixed methodologies that individual lenders cannot modify. The Pre-Fi Score enables each lending partner to define and deploy fully customized credit evaluation criteria for lead qualification, tailored to their specific risk appetite, product requirements, and market segment.

A further improvement of exemplary embodiments is the parametric Equation evaluation engine for configurable underwriting. Here, in this rules engine, underwriting criteria, scoring thresholds, and result matching conditions are stored as evaluable equations in a database, enabling partners to define arbitrarily complex business rules without code deployment.

Further, exemplary embodiments implement a dual-point Improvement pathway system, which is a credit factor evaluation system that maintains both ‘as-is’ and ‘if-fixed’ scoring with time-delayed projections, generating personalized remediation guidance for consumers.

Moreover, exemplary embodiments employ multi-bureau reconciliation with geographic weighting, where credit score calculation across multiple bureaus with configurable per-factor reconciliation modes (lowest, highest, sum) and geographic state-tier weighting that adjusts scoring based on regional credit profile variations.

In addition, exemplary embodiments employ an end-to-end automated pipeline from Minimal PII to Personalized Offers, where a single API request triggers the complete chain: fraud detection, identity resolution, credit pull with retry, multi-factor scoring, and dynamic offer generation with mortgage-specific calculations (LTV, DTI, PMI, regional estimates), all configurable per partner without code changes.

The above-mentioned embodiments of the present disclosure are only examples for describing the present disclosure more clearly, rather than limiting an implementation mode of the present disclosure. For those of ordinary skill in the art, other variations or changes in different forms can be made on the basis of the above description. It is impossible to list all implementation systems here. The obvious variations or changes derived from the technical solutions of the present disclosure still fall within the scope of protection of the present disclosure.

What is claimed is:

1. A remote personal data retrieval method for offering credit over a wide area network, comprising:
receiving, by a remote personal data retrieval (RPDR) server and from a client portal over the wide area network, pre-qualification information, wherein the pre-qualification information consists of at least two of: a user's name, a telephone number of the user and an email address of the user;
performing, by the RPDR server, a cascading multi-vendor search and validation process that establishes a verified consumer identity from the pre-qualification information without requiring a Social Security Number, the cascading multi-vendor search and validation process including generating a first search request including at least a portion of the pre-qualification information, transmitting the first search request to at least one identification (ID) vendor server over the wide area network, receiving identification information from the at least one ID vendor server over the wide area network, wherein the identification information comprises at least one of a birth date of the user, at least one physical address of the user or a legal name of the user, applying a confidence scoring threshold to the identification information, and, when the confidence scoring threshold is not satisfied, clearing personally identifiable information (PII) data captured from a failed attempt and initiating a new search cycle through another ID vendor server,
obtaining, by the RPDR server, at least one credit report of the user by
performing, before executing a full credit pull, a lightweight credit bureau precheck address cascade that validates the verified consumer identity against credit bureau records by sequentially attempting a primary address, a first historical address when the precheck fails with the primary address, and second historical address when the precheck fails with the first historical address,
terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy,
generating a second search request including at least a portion of the pre-qualification information and at least a portion of the identification information,
transmitting the second search request to at least one reporting vendor server over the wide area network,
receiving the at least one credit report from the at least one reporting vendor server in response to the second search request, wherein all information obtained from the user that is employed to obtain the at least one credit report is at most the pre-qualification information,
computing, a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null, and
when multiple credit bureau reports are available, calculating independent score values for respective credit bureaus and selecting a score having a value less than remaining independent score values as the qualifying score of the user; and
providing, by the RPDR server, a credit offer to the user by generating the credit offer based on the at least one credit report and the qualifying score, and transmitting the credit offer to the client portal over the wide area network.

2. The method of claim 1, wherein the at least one ID vendor server comprises a first ID vendor server that provides the identification information to the RPDR server and wherein the performing, by the RPDR server, the search and validation process comprises generating, by the RPDR server, a third search request including the telephone number of the user to determine whether the telephone number of the user is valid, transmitting the third search request to a second ID vendor server over the wide area network and receiving, from the second ID vendor and over the wide area network, an indication of whether the telephone number of the user is valid.

3. The method of claim 2, wherein the at least a portion of the prequalification information is the user's name, the indication comprises a locale associated with the telephone number and the second search request includes said locale, wherein the locale is at least one of a city associated with the telephone number or a state associated with the telephone number.

4. The method of claim 1, wherein the computing the qualifying score comprises applying the first formula by scaling internal points by a geographic state-tier weight, multiplying the scaled internal points by the six-tier revolving paydown multiplier, and adding a base offset of the second threshold.

5. The method of claim 1, wherein the six-tier revolving paydown multiplier adjusts scoring sensitivity based on revolving credit utilization percentage such that the six-tier revolving paydown multiplier decreases as the revolving credit utilization percentage increases.

6. The method of claim 1, wherein the identification information is first identification information, wherein the user's name includes a first name and a last name, wherein the at least a portion of the prequalification information includes the first name and the telephone number, wherein the search and validation process comprises generating a third search request including the last name and the telephone number, transmitting the third search request to the at least one ID vendor server over the wide area network, and receiving second identification information from the at least one ID vendor server over the wide area network in response to the third search request.

7. The method of claim 6, wherein the search and validation process comprises:
generating a fourth search request including the e-mail address and the telephone number,
transmitting the fourth search request to the at least one ID vendor server over the wide area network,
receiving third identification information from the at least one ID vendor server over the wide area network in response to the third search request,
comparing the first, second and third identification information to determine whether the third identification information matches any of the first or the second identification information, and
determining that a match between the third identification information and the first or the second identification information corresponds to the user, wherein the at least a portion of the identification information in the second search request comprises at least a portion of the identification information of said match.

8. A non-transitory computer readable storage medium comprising program code, wherein the program code is configured to cause at least one processor to perform the method of claim 1 when the at least one processor executes the program code.

9. A system for remote personal data retrieval for offering credit over a wide area network, comprising:
a search and validation (SV) module, implemented by at least one processor, wherein the at least one processor, in implementing the SV module, is configured to receive, from a client portal over the wide area network, pre-qualification information, wherein the pre-qualification information consists of at least two of: a user's name, a telephone number of the user and an email address of the user,
wherein the at least one processor, in implementing the SV module, is further configured to perform a cascading multi-vendor search and validation process that establishes a verified consumer identity from the pre-qualification information without requiring a Social Security Number by generating a first search request including at least a portion of the pre-qualification information, transmitting the first search request to at least one identification (ID) vendor server over the wide area network, receiving identification information from the at least one ID vendor server over the wide area network, wherein the identification information comprises at least one of a birth date of the user, at least one physical address of the user or a legal name of the user, applying a confidence scoring threshold to the identification information, and, when the confidence scoring threshold is not satisfied, clearing personally identifiable information (PII) data captured from a failed attempt and initiating a new search cycle through another ID vendor server;
an underwriting (UW) module, implemented by the at least one processor, wherein the at least one processor, in implementing the UW module, is configured to obtain at least one credit report of the user by
performing, before executing a full credit pull, a lightweight credit bureau precheck address cascade that validates the verified consumer identity against credit bureau records by sequentially attempting a primary address, a first historical address when the precheck fails with the primary address, and a second historical address when the precheck fails with the first historical address,
terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy,
generating a second search request including at least a portion of the pre-qualification information and at least a portion of the identification information,
transmitting the second search request to at least one reporting vendor server over the wide area network, and
receiving the at least one credit report from the at least one reporting vendor server in response to the second search request, wherein all information obtained from the user that is employed to obtain the at least one credit report is at most the pre-qualification information,
computing a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null, and
when multiple credit bureau reports are available, calculating independent score values for respective credit bureaus and selecting a score having a value less than remaining independent score values as the qualifying score of the user; and
an offer generator module, implemented by the at least one processor, wherein the at least one processor, in implementing the offer generator module, is configured to provide a credit offer to the user by generating the credit offer based on the at least one credit report and the qualifying score, and transmitting the credit offer to the client portal over the wide area network.

10. The system of claim 9, wherein the at least one ID vendor server comprises a first ID vendor server that provides the identification information to the SV module and wherein the search and validation process comprises generating a third search request including the telephone number of the user to determine whether the telephone number of the user is valid, transmitting the third search request to a second ID vendor server over the wide area network and receiving, from the second ID vendor and over the wide area network, an indication of whether the telephone number of the user is valid.

11. The system of claim 10, wherein the at least a portion of the prequalification information is the user's name, the indication comprises a locale associated with the telephone number and the second search request includes said locale, and wherein the locale is at least one of a city associated with the telephone number or a state associated with the telephone number.

12. The system of claim 9, wherein the at least one processor, in implementing the UW module, is configured to apply the first formula by scaling internal points by a geographic state-tier weight, multiplying the scaled internal points by the six-tier revolving paydown multiplier, and adding a base offset of the second threshold.

13. The system of claim 9, wherein the at least one processor, in implementing the UW module, is configured to apply the non-linear power-function fallback formula to prevent score collapse for a consumer having multiple negative credit factors.

14. The system of claim 10, wherein the identification information is first identification information, wherein the user's name includes a first name and a last name, wherein the at least a portion of the prequalification information includes the first name and the telephone number, wherein the search and validation process comprises generating a third search request including the last name and the telephone number, transmitting the third search request to the at least one ID vendor server over the wide area network, and receiving second identification information from the at least one ID vendor server over the wide area network in response to the third search request.

15. The system of claim 14, wherein the search and validation process comprises:
generating a fourth search request including the e-mail address and the telephone number; transmitting the fourth search request to the at least one ID vendor server over the wide area network; receiving third identification information from the at least one ID vendor server over the wide area network in response to the third search request; comparing the first, second and third identification information to determine whether the third identification information matches any of the first or the second identification information; and determining that a match between the third identification information and the first or the second identification information corresponds to the user, wherein the at least a portion of the identification information in the second search request comprises at least a portion of the identification information of said match.

16. A system for remote personal data retrieval for offering credit over a wide area network comprising:
a remote personal data retrieval (RPDR) server implemented by at least one processor;
a client portal configured to transmit, over the wide area network, pre-qualification information, wherein the pre-qualification information consists of at least two of: a user's name, a telephone number of the user and an email address of the user; and
at least one identification (ID) vendor server;
at least one reporting vendor server;
wherein the at least one processor, in implementing the RPDR server, is configured to
perform a cascading multi-vendor search and validation process that establishes a verified consumer identity from the pre-qualification information without requiring a Social Security Number by generating a first search request including at least a portion of the pre-qualification information, transmitting the first search request to the at least one ID vendor server over the wide area network, receiving identification information from the at least one ID vendor server over the wide area network, wherein the identification information comprises at least one of a birth date of the user, at least one physical address of the user or a legal name of the user, applying a confidence scoring threshold to the identification information, and, when the confidence scoring threshold is not satisfied, clearing personally identifiable information (PII) data captured from a failed attempt and initiating a new search cycle through another ID vendor server;
obtain at least one credit report of the user by
performing, before executing a full credit pull, a lightweight credit bureau precheck address cascade that validates the verified consumer identity against credit bureau records by sequentially attempting a primary address, a first historical address when the precheck fails with the primary address, and a second historical address when the precheck fails with the first historical address,
terminating a credit-pull pipeline without executing the full credit pull in response to a stop-processing signal returned by the lightweight credit bureau precheck address cascade, wherein the stop-processing signal indicates at least one of a credit freeze, a credit lock, an age mismatch, or an address discrepancy,
generating a second search request including at least a portion of the pre-qualification information and at least a portion of the identification information, transmitting the second search request to the at least one reporting vendor server over the wide area network, and receiving the at least one credit report from the at least one reporting vendor server in response to the second search request, wherein all information obtained from the user that is employed to obtain the at least one credit report is at most the pre-qualification information,
computing a qualifying score for the user from the at least one credit report using a two-layer scoring architecture in which a normalized internal score is converted to a standard credit score range using a dual-formula conversion comprising a first formula having a six-tier revolving paydown multiplier and a non-linear power-function fallback formula that bounds a fallback score between a first threshold and a second threshold when the first formula produces a score below the second threshold or returns null,
when multiple credit bureau reports are available, calculating independent score values for respective credit bureaus and selecting a score having a value less than remaining independent score values as the qualifying score of the user; and
wherein the at least one processor, in implementing the RPDR server, is configured to provide a credit offer to the user by generating the credit offer based on the at least one credit report and the qualifying score, and transmitting the credit offer to the client portal over the wide area network.

17. The system of claim 16, wherein the at least one ID vendor server comprises a first ID vendor server that provides the identification information to the RPDR server and wherein the system further comprises:
at least one second ID vendor server, wherein the RPDR server is configured to perform the search and validation process by generating a third search request including the telephone number of the user to determine whether the telephone number of the user is valid, transmitting the third search request to the second ID vendor server over the wide area network and receiving, from the second ID vendor and over the wide area network, an indication of whether the telephone number of the user is valid.

18. The system of claim 17, wherein the generating the first search request and the transmitting the first search request is performed on condition that the indication indicates that the telephone number of the user is valid.

19. The system of claim 16, wherein the identification information is first identification information, wherein the user's name includes a first name and a last name, wherein the at least a portion of the prequalification information includes the first name and the telephone number, wherein the search and validation process comprises generating a third search request including the last name and the telephone number, transmitting the third search request to the at least one ID vendor server over the wide area network, and receiving second identification information from the at least one ID vendor server over the wide area network in response to the third search request.

20. The system of claim 16, wherein the search and validation process comprises generating a fourth search request including the e-mail address and the telephone number; transmitting the fourth search request to the at least one ID vendor server over the wide area network; receiving third identification information from the at least one ID vendor server over the wide area network in response to the third search request; comparing the first, second and third identification information to determine whether the third identification information matches any of the first or the second identification information; and determining that a match between the third identification information and the first or the second identification information corresponds to the user, wherein the at least a portion of the identification information in the second search request comprises at least a portion of the identification information of said match.
